(19) United States
(12) Patent Application Publication
(10) Pub. No.: US 2014/0164258 A1
(43) Pub. Date: Jun. 12, 2014

(54) MOBILE STATION APPARATUS AND COMMUNICATION METHOD THEREOF

(71) Applicant: FUJITSU LIMITED, Kawasaki-shi (JP)

(72) Inventor: Masaaki SUZUKI, Yokohama (JP)

(73) Assignee: FUJITSU LIMITED, Kawasaki-shi (JP)

(21) Appl. No.: 14/095,398

(22) Filed: Dec. 3, 2013

(30) Foreign Application Priority Data
Dec. 11, 2012 (JP) 2012-270451

(51) Int. Cl. G06Q 10/00; H04W 12/06

(52) U.S. Cl. CPC G06Q 10/20; H04W 12/06
USPC 705/305; 455/411

(57) ABSTRACT

A mobile station apparatus includes a memory and a processor. The processor is configured to receive a first identifier used to identify an electronic device other than the mobile station apparatus. The processor is configured to authenticate the electronic device by using a combination of the first identifier and a second identifier. The second identifier is available to identify the mobile station apparatus or a user of the mobile station apparatus. The processor is configured to obtain first data about the authenticated electronic device from a server apparatus through authenticated communication between the mobile station apparatus and the server apparatus.

### CROSS-REFERENCE TO RELATED APPLICATION

This application is based upon and claims the benefit of priority from the prior Japanese Patent Application No. 2012-270451 filed on Dec. 11, 2012, the entire contents of which are incorporated herein by reference.

### FIELD

The embodiment discussed herein is related to a mobile station apparatus and a communication method thereof.

### BACKGROUND

Electronic apparatuses, other than information communication devices, that have network functions have been used in recent years. Examples of these electronic apparatuses are network-connected home appliances.

A mobile information terminal apparatus known as a related technology has an externally connected unit that receives different types of software from a terminal apparatus that may perform two-way communication with a center. The mobile information terminal apparatus has a storage unit that stores the different types of software received by the externally connected unit, and also has a display unit on which functions related to the types of software are displayed according to the types of software stored in the storage unit. The mobile information terminal apparatus further has an operation unit used to select a function displayed on the display unit and a control unit that executes software corresponding to the function selected through the operation unit.

It is also known that wireless communication functions are incorporated into a refrigerator, a washing machine, a microwave oven, a television set, a videocassette recorder, and other home appliances to create a wireless local area network (LAN) between these home appliances and a home terminal. It is also known that a user manipulates a mobile terminal in a place away from home to access a home terminal connected with the Internet and remotely manipulate various types of home appliances or remotely monitor the states of these home appliances. With a known home LAN, the user or an organization is automatically notified of an abnormal condition of a home appliance, if it occurs, through the home terminal.

Related techniques are disclosed in, for example, Japanese Laid-open Patent Publication No. 2002-317942 and Japanese Laid-open Patent Publication No. 2004-288201.

For an electronic apparatus that is not connected directly to a network, a user registration procedure, procedures for receiving after-sales care, and other services have involved many types of manual processes by the user and have been thereby complex, for example, for receiving functional improvements after shipping and asking for or receiving troubleshooting assistance.

### SUMMARY

According to an aspect of the present invention, a mobile station apparatus including a memory and a processor is provided. The processor is configured to receive a first identifier used to identify an electronic device other than the mobile station apparatus. The processor is configured to authenticate the electronic device by using a combination of the first identifier and a second identifier. The second identifier is available to identify the mobile station apparatus or a user of the mobile station apparatus. The processor is configured to obtain first data about the authenticated electronic device from a server apparatus through authenticated communication between the mobile station apparatus and the server apparatus.

The objects and advantages of certain embodiments will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary configuration of a communication system;

FIG. 2 is a block diagram illustrating an exemplary functional configuration of a mobile station apparatus;

FIG. 3 is a block diagram illustrating an exemplary functional configuration of a home appliance;

FIG. 4 is a block diagram illustrating an exemplary functional configuration of a device management server apparatus;

FIG. 5 is a sequence diagram illustrating an operation sequence of device registration processing;

FIG. 6 is a sequence diagram illustrating an operation sequence of update data confirmation processing;

FIG. 7 is a sequence diagram illustrating an operation sequence of update data confirmation processing;

FIG. 8 is a sequence diagram illustrating an operation sequence of a processing performed at occurrence of a recall;

FIG. 9 is a sequence diagram illustrating an operation sequence of a processing performed at occurrence of a failure;

FIG. 10 is a sequence diagram illustrating an operation sequence of a processing performed when a utilization site of a home appliance is changed;

FIG. 11 is a sequence diagram illustrating an operation sequence of a processing performed when a home appliance is handed over;

FIG. 12 is a sequence diagram illustrating an operation sequence of a processing performed when a response to a questionnaire is collected;

FIG. 13 is a block diagram illustrating an exemplary hardware configuration of a mobile station apparatus;

FIG. 14 is a block diagram illustrating an exemplary hardware configuration of a home appliance; and

FIG. 15 is a block diagram illustrating an exemplary hardware configuration of a device management apparatus.

### DESCRIPTION OF EMBODIMENTS

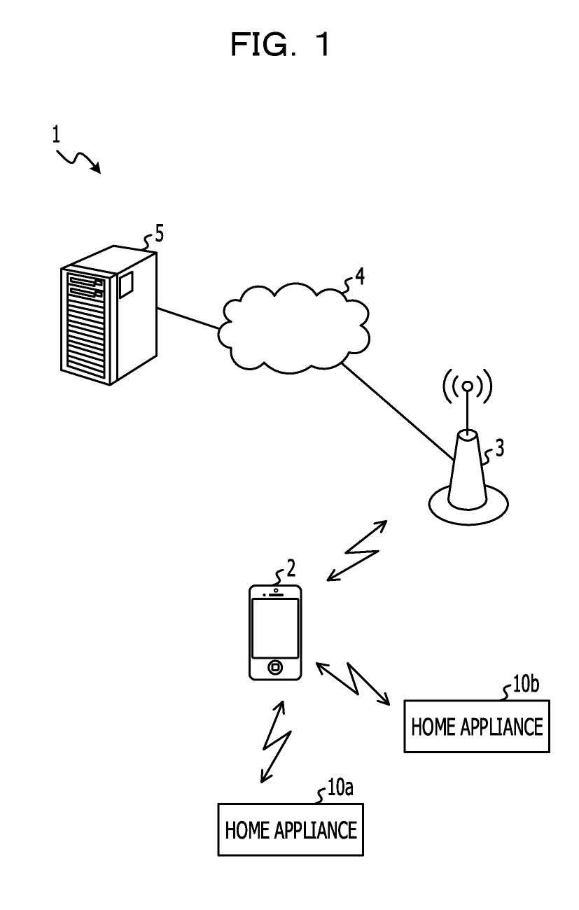

Embodiments will be described below with reference to the attached drawings. FIG. 1 illustrates an exemplary configuration of a communication system. A communication system 1 includes a mobile station apparatus 2, a base station apparatus 3, a communication network 4, a device management server apparatus 5, and home appliances 10a and 10b. In the descriptions below, the terms “mobile station apparatus”, “base station apparatus”, and “device management server apparatus” may be respectively referred to as “mobile station”, “base station”, and “device management server”. The home appliances 10a and 10b may be collectively referred to as the home appliances 10.

The mobile station 2 communicates with the device management server 5 through a wireless access network, intended for mobile communication services, between the mobile station 2 and the base station 3 and through the communication network 4. The mobile station 2 may be, for example, a personal computer, a personal digital assistant (PDA), a smart phone, or a mobile telephone.

The communication network 4 may be, for example, the Internet or an intranet, and a core network, provided by a communication carrier, which connects the Internet or the intranet to the wireless access network.

The device management server 5 is a server that stores product information about the home appliances 10, information about a user associated with the home appliances 10, update data to be used to update a control program or add-on function of the home appliances 10, and data of various types of information related to the home appliances 10. The device management server 5 is used in after-sales care processing performed for the home appliances 10 through the mobile station 2 connectable with the device management server 5.

The after-sales care processing performed for the home appliances 10 includes processing (1) to (3) below.

(1) Providing of update data to be used to update the control program or add-on function of the home appliances 10

(2) Maintenance assistance for the home appliances 10

The maintenance assistance for the home appliances 10 includes, for example, providing of periodic maintenance guidance, a notification of a recall, guidance of repair application, and other maintenance information. The maintenance assistance for the home appliances 10 also includes acceptance of a repair application.

(3) Providing of information related to the home appliances 10

The providing of information related to the home appliances 10 includes, for example, providing of information about events and new products related to the home appliances 10, information about operation procedures, and a product manual, notifications of questionnaires about the home appliances 10 and recruitments of monitors.

In the descriptions below, the after-sales care processing for the home appliances 10 may be simply referred to as the after-sales care processing and update data to be used to update the control program or add-on function of the home appliances 10 may be simply referred to as update data.

Product information about the home appliances 10, information about a user, update data, and other various types of data may be stored in a single device management server 5 or may be individually stored in a plurality of device management servers 5. The device management servers 5 may be managed by, for example, the manufacturer of the home appliances 10. Part or the whole of the configuration of the device management server 5 may be provided by an external data storage service provider rather than the manufacturer.

Each home appliance 10 is an electronic device that lacks a communication interface directly connectable with the communication network 4 or with a wireless access network intended for mobile communication service. The home appliance 10 may be, for example, a white good, an audio device, a device for household chores, or a video device.

The home appliance 10 has a wired or wireless interface for communication between the home appliance 10 and the mobile station 2. The home appliance 10 and mobile station 2 may mutually communicate through, for example, a wired connection such as general-purpose cable typified by a universal serial bus (USB) cable or a device-specific cable. Alternatively, the home appliance 10 and mobile station 2 may mutually communicate through a wireless connection in short-distance wireless communication based on the Bluetooth™ technology, the Near Field Communication (NFC) technology or the like, in wireless fidelity (WiFi) communication, in infrared communication, or in another type of wireless communication.

The home appliance 10 may communicate with the mobile station 2 through the above wired or wireless interface to receive update data that the mobile station 2 has downloaded from the device management server 5 and may update the control program or add-on function of the home appliances 10 with the received update data.

The home appliance 10 may include a drive unit that may read from and write to a recording medium, such as a removable medium, which is removable. The removable medium may be, for example, a secure digital (SD) card, a CompactFlash (registered trademark) card, or a USB memory. The home appliance 10 may read the update data that the mobile station 2 has downloaded from the device management server 5 and has written to a recording medium and may update the control program or add-on function of the home appliances 10 with the read update data.

The mobile station 2 has a processor that performs processing to download update data from the device management server 5 and processing to receive maintenance information and also has a management application program executed by the processor to perform these types of processing. The mobile station 2 may have a drive unit that writes the update data to the removable medium.

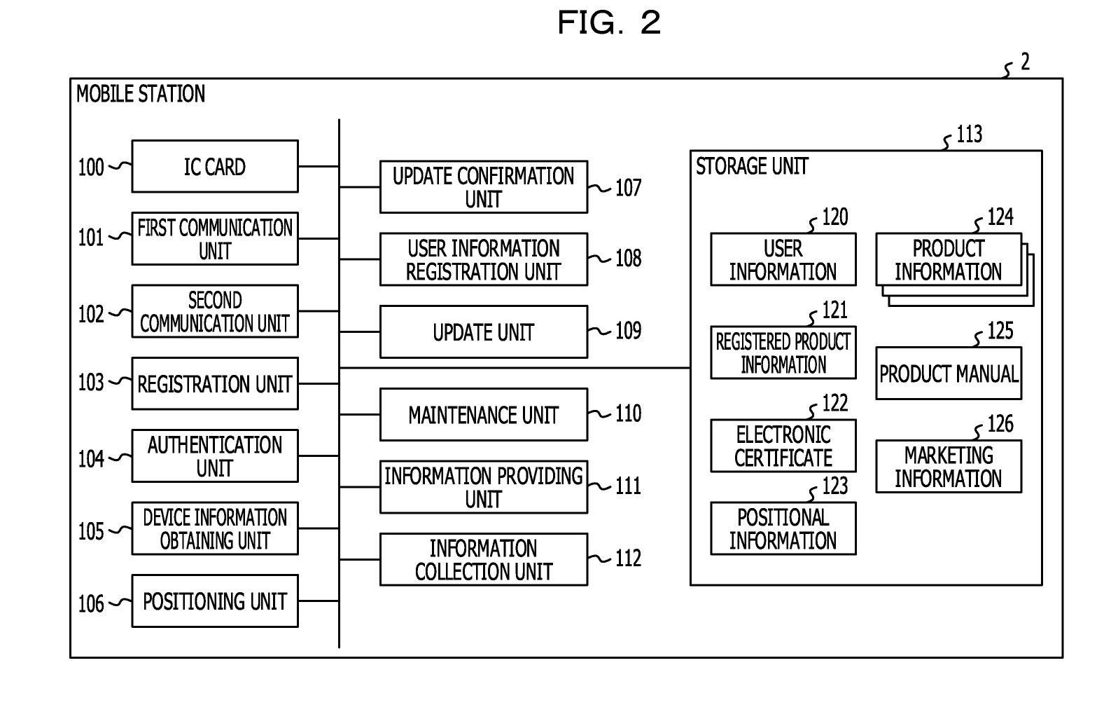

FIG. 2 is a block diagram illustrating an exemplary functional configuration of the mobile station 2. The mobile station 2 includes an integrated circuit (IC) card 100, a first communication unit 101, a second communication unit 102, a registration unit 103, an authentication unit 104, a device information obtaining unit 105, a positioning unit 106, and an update confirmation unit 107. The mobile station 2 also includes a user information registration unit 108, an update unit 109, a maintenance unit 110, an information providing unit 111, an information collection unit 112, and a storage unit 113.

The IC card 100 has a storage element in which an identifier available to identify the mobile station 2 or its user is stored. The IC card 100 may be, for example, a subscriber identity module (SIM) card or a universal subscriber identity module (USIM) card. In this case, an international mobile subscriber identity (IMSI) is used to identify the user of the mobile station 2. The IC card 100 may be a contact card such as a debit card, a credit card, or a bank card. Alternatively, the IC card 100 may be a non-contact card such as a personal authentication card or a prepaid riding ticket card.

An example will be described below in which an IMSI is used as an identifier available to identify the mobile station 2. However, this example is not intended to limit identifiers available to identify the mobile station 2 to an IMSI.

For example, in another embodiment, the identifier that identifies the mobile station 2 may be used as an identifier available to identify the mobile station 2 or its user. An example of the identifier that identifies the mobile station 2 is an international mobile equipment identity (IMEI) or a mobile equipment identifier (MEID).

The first communication unit 101 performs processing for communication between the mobile station 2 and the home appliance 10 through the wired or wireless interface, described above, between the mobile station 2 and the home appliance 10. The second communication unit 102 performs processing for communication between the mobile station 2 and the device management server 5. Specifically, the second communication unit 102 performs processing to establish prescribed encrypted communication between the second communication unit 102 and the device management server 5, and transmits and receives data or information to and from the device management server 5 through the authenticated communication. An electronic certificate 122 of the mobile station 2 is stored in the storage unit 113. The electronic certificate 122 is used to authenticate communication with the device management server 5.

The registration unit 103 performs processing to register the home appliance 10 in the mobile station 2. After the home appliance 10 has been registered in the mobile station 2, the after-sales care processing by the device management server 5 may be received through the mobile station 2. That is, registration of the home appliance 10 in the mobile station 2 is an example of registration of the mobile station 2, which relays the after-sales care processing performed for the home appliance 10. In the descriptions below, processing performed by the registration unit 103 to register the home appliance 10 may be referred to as device registration processing.

In the device registration processing, the registration unit 103 reads out the IMSI from the IC card 100. The registration unit 103 receives from the home appliance 10 through communication performed by the first communication unit 101, a device identifier that identifies the home appliance 10. The registration unit 103 stores registered product information 121, which associates the IMSI and device identifier with each other, in the storage unit 113.

When the home appliance 10 receives the after-sales care processing from the device management server 5, the authentication unit 104 performs processing to authenticate a user who will activate the management application program. The user identifier and password of the user who may use the management application program are stored in the storage unit 113 as user information 120. Additionally, the user information 120 may include the user's address, the telephone number of the mobile station 2, a mailing address, and other information elements.

The authentication unit 104 receives the user identifier and password entered by the user. When the entered user identifier and password match the user identifier and password stored as the user information 120, the authentication unit 104 authenticates the user who will use the management application program. The authentication unit 104 also transmits the user identifier and password to the device management server 5 so that they are used in processing to authenticate a user account set in the device management server 5.

The authentication unit 104 authenticates the home appliance 10 that is intended to receive the after-sales care processing from the device management server 5. Specifically, the authentication unit 104 receives the device identifier from the target home appliance 10 and reads the IMSI from the IC card 100. When the device identifier received from the home appliance 10 is associated with the IMSI in the registered product information 121, the authentication unit 104 authenticates the home appliance 10.

The device information obtaining unit 105 obtains device information about the home appliance 10 from the authenticated home appliance 10. The device information includes at least any one of the product information, status information, and error information about the home appliance 10. The device information obtaining unit 105 stores the obtained product information in the storage unit 113 as product information 124.

The product information 124 may include a model number of the home appliance 10, a device identifier, a manufacturing factory, a date and time of manufacturing, a date and time of purchase, and a version number of the control program.

The status information may include information that specifies the internal state of the home appliance 10. In addition, the status information may include information about the current internal state of the home appliance 10 and status history information, which represents previous internal states of the home appliance 10.

The error information may include error code information that specifies an error that has occurred. In addition, the error information may include information about a current error and error history information about errors that occurred in the past. The error history information may include error code information and occurrence date and time information.

The positioning unit 106 uses the Global Positioning System (GPS) or an advanced forward link trilateration (AFLT) system, or another positioning system to identify the location of the mobile station 2. The positioning unit 106 stores positional information about the mobile station 2 in the storage unit 113 as positional information 123. The update confirmation unit 107 transmits the product information 124 and the positional information 123 to the device management server 5 and checks whether there is update data for the home appliance 10, that is, whether the control program or add-on function has been updated.

The user information registration unit 108 transmits the user information 120 stored in the storage unit 113 to the device management server 5 to register the user information 120 in a prescribed database in the device management server 5.

The user information registration unit 108 also transmits the user information 120 stored in the storage unit 113 to the device management server 5 to update user information registered in the prescribed database in the device management server 5.

When the update confirmation unit 107 has confirmed that there is update data, the update unit 109 asks the device management server 5 to transmit the update data and downloads the update data. The update unit 109 then performs processing to update the control program or add-on function of the home appliance 10 with the downloaded update data. Upon completion of the update of the control program or add-on function, the update unit 109 notifies the device management server 5 of the completion. The update completion notification may include a version number of the update data.

If the home appliance 10 is recalled, the maintenance unit 110 accepts a request to start recall processing from the user. The maintenance unit 110 may receive a recall notification from the device management server 5 and may automatically start the recall processing. If the home appliance 10 fails, the maintenance unit 110 accepts a request to start inspection and repair processing from the user.

In the recall processing and the inspection and repair processing, the maintenance unit 110 transmits the product information, status information and error information obtained from the home appliance 10 and the positional information 123 about the mobile station 2 to the device management server 5 and makes an inquiry about whether to repair the hardware of the home appliance 10. When the device management server 5 determines, based on the product information, status information and error information, that it is desirable to repair the hardware of the home appliance 10, the device management server 5 transmits repair guidance information that prompts the user to issue a repair request.

Upon receipt of the repair guidance information, the maintenance unit 110 accepts an operation made by the user to request repair. The maintenance unit 110 notifies the device management server 5 of the repair request for the home appliance 10.

After repair requirements have been determined, the device management server 5 notifies the maintenance unit 110 that the repair request has been accepted. In the repair requirements, a type of execution such as carry-in service or field repair, a date and time of repair, a work site, and other information are specified, for example. A maintenance person may adjust the repair requirements in consultation with the user by telephone, mail, or another method.

The device management server 5 may execute an automatic response program to adjust the repair requirements in consultation with the user. The maintenance unit 110 may create a dialogue interface between the user and the device management server 5 executing the automatic response program to adjust the repair requirements.

The repair request acceptance notification may include a notification of a repair schedule and a notification as to whether the home appliance 10 may continue to be used until it is repaired. Upon receipt of the repair request acceptance notification, the maintenance unit 110 displays the repair schedule and availability of continued use of the home appliance 10 for the user.

The information providing unit 111 receives various types of information transmitted from the device management server 5 and displays them for the user. The information received by the information providing unit 111 from the device management server 5 includes, for example, guidance of events, new products related to the home appliances 10, information about operation procedures, a product manual, notifications of questionnaires about the home appliances 10, and notifications of recruitments of monitors. The information providing unit 111 may accept the user's operation to request the device management server 5 to provide the product manual and may request the device management server 5 to provide the product manual in response to the user's operation. The product manual provided by the device management server 5 is stored in the storage unit 113 as a product manual 125.

The information collection unit 112 accepts a response input operation that the user has made in response to the questionnaire notification from the device management server 5. The purpose of the questionnaire may be, for example, to collect a product opinion about the home appliance 10 or investigate the tastes and habits of the user according to the product attribute of the home appliance 10. The information collection unit 112 stores product opinion information, which is a response to the questionnaires, and other questionnaire result information in the storage unit 113 as marketing information 126. The information collection unit 112 transmits the marketing information 126 to the device management server 5 in response to the notification of the questionnaire from the device management server 5.

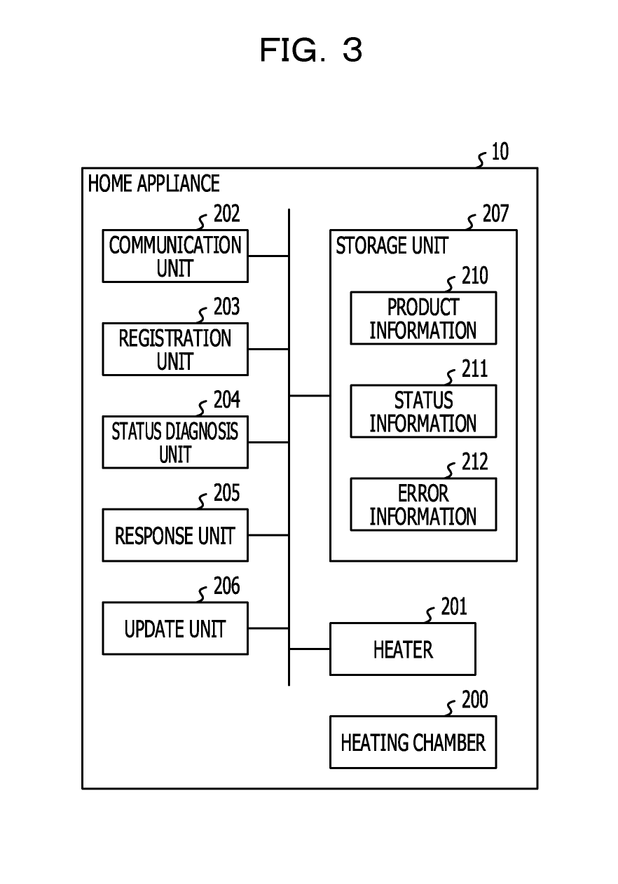

FIG. 3 is a block diagram illustrating an exemplary functional configuration of the home appliance 10. An example will be described in which the home appliance 10 is a microwave oven that heats food placed in a heating chamber 200 by using a heater 201. However, this example is not intended to limit the home appliance 10 to a microwave oven.

The home appliance 10 has a communication unit 202, a registration unit 203, a status diagnosis unit 204, a response unit 205, an update unit 206, and a storage unit 207.

The communication unit 202 performs processing for communication between the mobile station 2 and the home appliance 10 through the wired or wireless interface provided between the mobile station 2 and the home appliance 10. The registration unit 203 transmits a device identifier to the mobile station 2 in the device registration processing.

The status diagnosis unit 204 diagnoses the current internal state of the home appliance 10. The status diagnosis unit 204 stores status information 211 in the storage unit 207. In authentication of the home appliance 10 by the authentication unit 104 in the mobile station 2, the response unit 205 transmits the device identifier to the mobile station 2 in response to a request from the authentication unit 104.

The response unit 205 also transmits device information in response to a device information request received from the device information obtaining unit 105 in the mobile station 2. The device information may include at least any one of product information 210, the status information 211, and error information 212 about the home appliance 10, which have been stored in the storage unit 207.

The update unit 206 performs processing to update the control program or add-on function of the home appliance 10 with update data. Upon completion of the update of the control program or add-on function, the update unit 206 notifies the mobile station 2 of the completion. The update completion notification may include a version number of the update data.

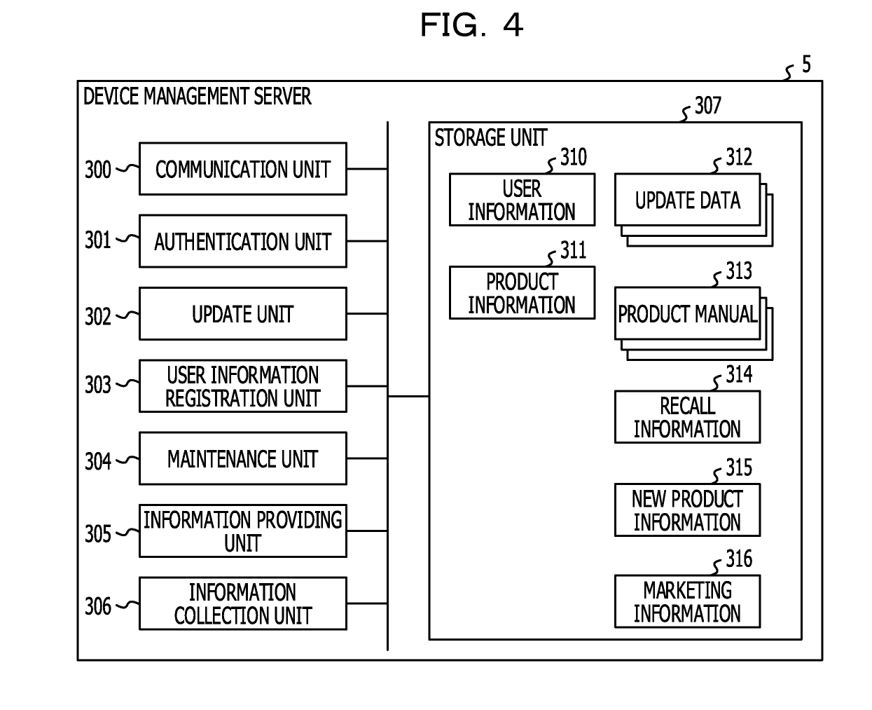

FIG. 4 is a block diagram illustrating an exemplary functional configuration of the device management server 5. The device management server 5 includes a communication unit 300, an authentication unit 301, an update unit 302, a user information registration unit 303, a maintenance unit 304, an information providing unit 305, an information collection unit 306, and a storage unit 307.

The communication unit 300 performs processing for communication between the mobile station 2 and the device management server 5. Specifically, the communication unit 300 performs processing to establish prescribed encrypted communication between the communication unit 300 and the mobile station 2 and transmits and receives data or information to and from the mobile station 2 through the authenticated communication.

The authentication unit 301 receives, from the mobile station 2, the user identifier and password used by the user to log in to an account. The authentication unit 301 then performs processing to authenticate the user who will undergo the after-sales care processing by the device management server 5. Specifically, the authentication unit 301 identifies the user according to whether the received user identifier and password matches the user identifier and password for the account of the user, which is stored in the storage unit 307 as the user information 310.

The user information 310 stored in the storage unit 307 may include the user identifier, password, and address of the user, the telephone number of the mobile station 2, a mailing address, and an electronic certificate issued for the mobile station 2. The user information 310 may include the device identifier of the home appliance 10, which has been registered in the mobile station 2, as the device identifier of a home appliance owned by the user.

Product information 311 of home appliances owned by individual users is stored in the storage unit 307. The product information 311 related to the individual users may be referenced by using device identifiers included in both the user information 310 and the product information 311.

The update unit 302 determines, according to the version number in the product information transmitted from the mobile station 2, whether update data 312 for the home appliance 10 is present in the storage unit 307. When the update data 312 is present, the update unit 302 transmits update information to the mobile station 2, which indicates that the update data 312 is present.

In an area where a 50-Hz commercial power is used, for example, neither the control program nor add-on function may be updated. However, in an area where a 60-Hz commercial power is used, the control program or add-on function may be updated. With a home appliance 10 intended to be used in a cold area, the control program or add-on function may be updated. With a home appliance 10 intended to be used in another area, however, neither the control program nor add-on function may be updated. Accordingly, the update unit 302 may determine, based on positional information about the mobile station 2 or address information about the user, whether the update data 312 to be used to update the home appliance 10 is present.

Upon receiving from the mobile station 2 a request to transmit the update data, the update unit 302 transmits the update data 312 to the mobile station 2. When the update unit 302 is notified by the mobile station 2 that update of the control program or add-on function has been completed, the update unit 302 rewrites the version number in the product information 311 about the home appliance 10 with the version number of the update data 312 that has been transmitted. The update unit 302 may rewrite the version number in the product information 311 with the version number of the update data, which is included in the update completion notification received from the mobile station 2.

When the user information registration unit 303 receives user information from the mobile station 2, the user information registration unit 303 stores the received user information in the storage unit 307 as the user information 310. Alternatively, when the user information registration unit 303 receives user information from the mobile station 2, the user information registration unit 303 updates the user information 310 stored in the storage unit 307 with the user information received from the mobile station 2.

When the user information registration unit 303 receives product information from the mobile station 2, the user information registration unit 303 determines whether the product information 311 about the home appliance 10 related to the received product information has been stored in the storage unit 307. For example, the user information registration unit 303 may determine, based on the device identifier included in the product information 311, whether the product information 311 about an identical home appliance 10 has been stored in the storage unit 307. When the product information 311 has not been stored in the storage unit 307, the user information registration unit 303 stores the received product information in the storage unit 307 as the product information 311 about the home appliance 10 owned by the user. The user information registration unit 303 also stores the device identifier in the user information 310.

If the device identifier in the product information received from the mobile station 2 is included in the user information 310 about another user, the user information registration unit 303 removes the device identifier from the user information 310.

The maintenance unit 304 identifies, from among the home appliances 10 for which the product information 311 has been stored, a home appliance 10 eligible for being recalled according to recall information 314 stored in the storage unit 307. The recall information 314 may include, for example, any one of the model number of the home appliance 10, a device identifier, a manufacturing factory, a date and time of manufacturing, and a version number, as well as information that specifies a problem, in the home appliance 10, due to which the home appliance 10 is recalled.

The maintenance unit 304 identifies, based on the user information 310, the user of the home appliance 10 eligible for being recalled and transmits a notification of a recall to the mobile station 2 of the identified user. For example, the maintenance unit 304 may transmit a short message service (SMS) message or e-mail according to the telephone number or mailing address in the user information 310 to notify of the recall.

When the maintenance unit 304 receives the product information, status information, and error information about the home appliance 10 from the mobile station 2, the maintenance unit 304 determines, based on the received product information, whether the home appliance 10 is eligible for being recalled.

For example, in an area where a 50-Hz commercial power is used, no problem may occur. However, in an area where a 60-Hz commercial power is used, a problem may occur. A home appliance 10 intended to be used in a cold area may cause a problem, but a home appliance 10 intended to be used in another area may not cause a problem. Accordingly, the maintenance unit 304 may determine, from the positional information about the mobile station 2 or the address of the user, whether the home appliance 10 is eligible for being recalled.

When, in the inspection and repair processing for the home appliance 10, the maintenance unit 304 receives the product information, status information, and error information about the home appliance 10 from the mobile station 2, the maintenance unit 304 determines a type of failure in the home appliance 10 according to the error code included in the error information.

In the recall processing or the inspection and repair processing, the maintenance unit 304 determines, based on the status information and error information, the product status of the home appliance 10 and determines whether it is desirable to repair the hardware of the home appliance 10 or the problem may be solved by updating the control program or add-on function. If it is desirable to repair the hardware of the home appliance 10, the maintenance unit 304 transmits, to the mobile station 2, repair guidance information that prompts the user to issue a repair request. The maintenance unit 304 receives a repair request made for the home appliance 10 from the mobile station 2.

After repair requirements have been determined, the maintenance unit 304 notifies the mobile station 2 of that the repair request has been accepted. The maintenance unit 304 may adjust the repair requirements in consultation with the user by executing an automatic response program to have a dialogue with the user, who operates the mobile station 2 to make input operations. The maintenance unit 304 may specify an organization or a person responsible for performing repair work for the hardware of the home appliance 10, according to the positional information about the mobile station 2 and the address information about the user.

The information providing unit 305 receives the product information about the home appliance 10 and the positional information about the mobile station 2 from the mobile station 2. The information providing unit 305 determines, based on the received product information, whether there is information to be provided with respect to the home appliance 10 owned by the user of the mobile station 2. The information to be provided with respect to the home appliance 10 may be, for example, new product information 315 related to the home appliance 10, which is stored in the storage unit 307. Other examples of information provided with respect to the home appliance 10 include guidance of events for the home appliance 10, information about an operation procedure, a notification of a questionnaire about the home appliance 10, and a notification of a recruitment of monitors.

The information providing unit 305 may determine whether guidance of events for the home appliance 10, a notification of a questionnaire about the home appliance 10, and a notification of a recruitment of monitors may be provided according to the positional information about the mobile station 2 and the address information about the user.

The information providing unit 305 may accept a request for a product manual of the home appliance 10 from the mobile station 2. Upon receipt of the request, the information providing unit 305 transmits a product manual 313, stored in the storage unit 307, of the home appliance 10 to the mobile station 2.

The information collection unit 306 receives questionnaire result information and product opinion information transmitted from the mobile station 2. The information collection unit 306 stores the received questionnaire result information and product opinion information in the storage unit 307 as marketing information 316.

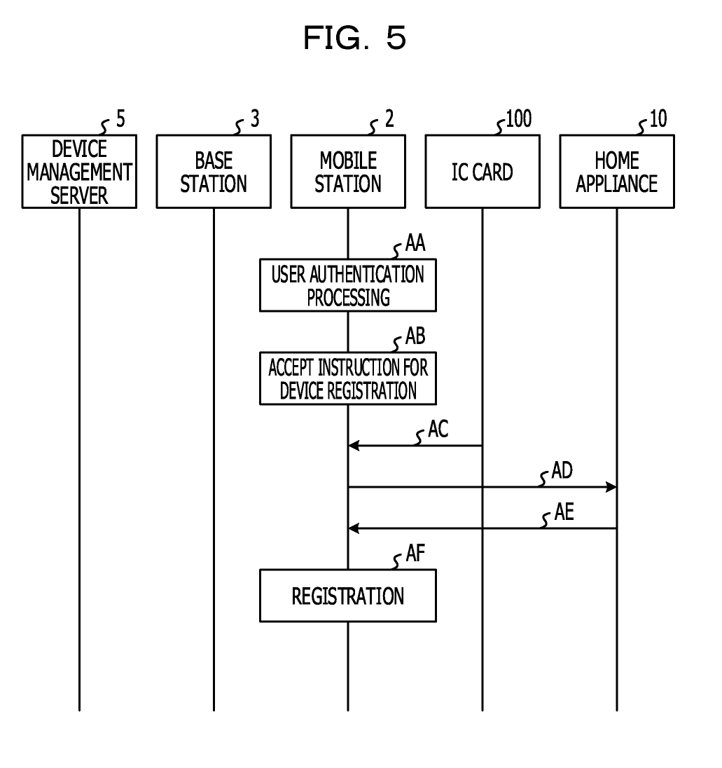

FIG. 5 illustrates an operation sequence of the device registration processing. In AA, the mobile station 2 performs processing to authenticate a user who will activate the management application program. The mobile station 2 accepts a user identifier and password entered by the user. When they match the user identifier and password stored as the user information 120, the mobile station 2 authenticates the user who will use the management application program. AA is performed by the authentication unit 104.

In AB, when the management application program is activated, the mobile station 2 accepts, on a graphical user interface (GUI) according to the management application program, an operation for requesting the device registration processing for the home appliance 10. In AC, the mobile station 2 reads out an IMSI from the IC card 100. In AD, the mobile station 2 requests the home appliance 10 to transmit the device identifier of the home appliance 10. AB through AD are performed by the registration unit 103.

In AE, the home appliance 10 transmits the device identifier of the home appliance 10 in response to the request for transmitting the device identifier from the mobile station 2. AE is performed by the registration unit 203.

In AF, the mobile station 2 stores the IMSI and device identifier in association with each other in the storage unit 113 as the registered product information 121. AF is performed by the registration unit 103. This completes the device registration processing.

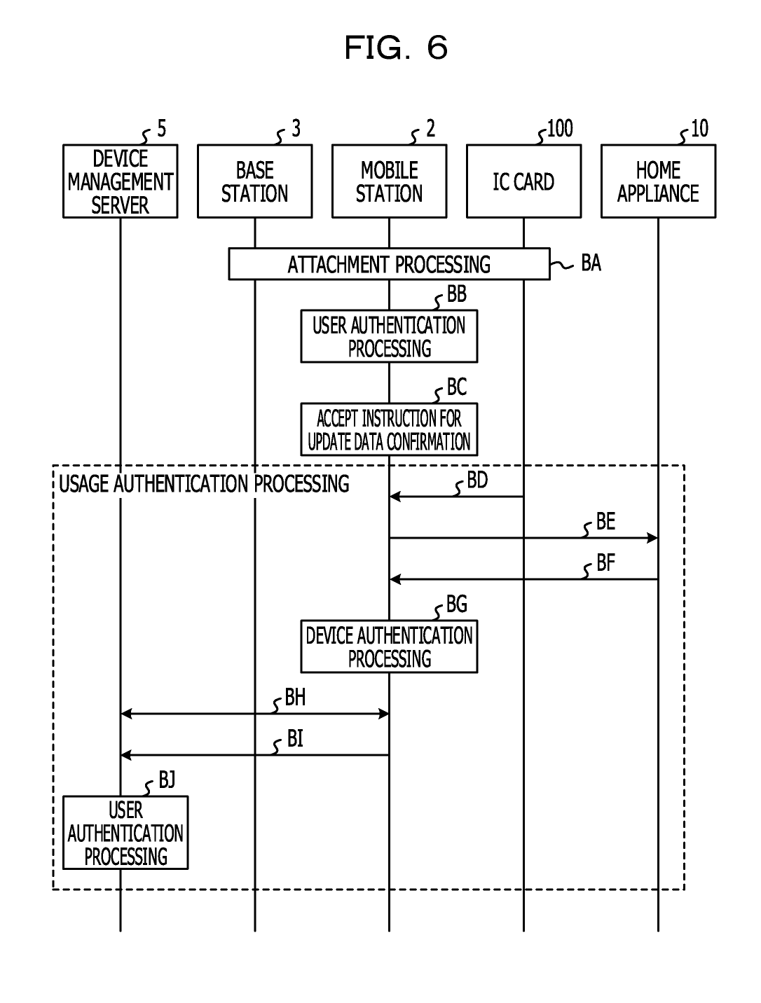

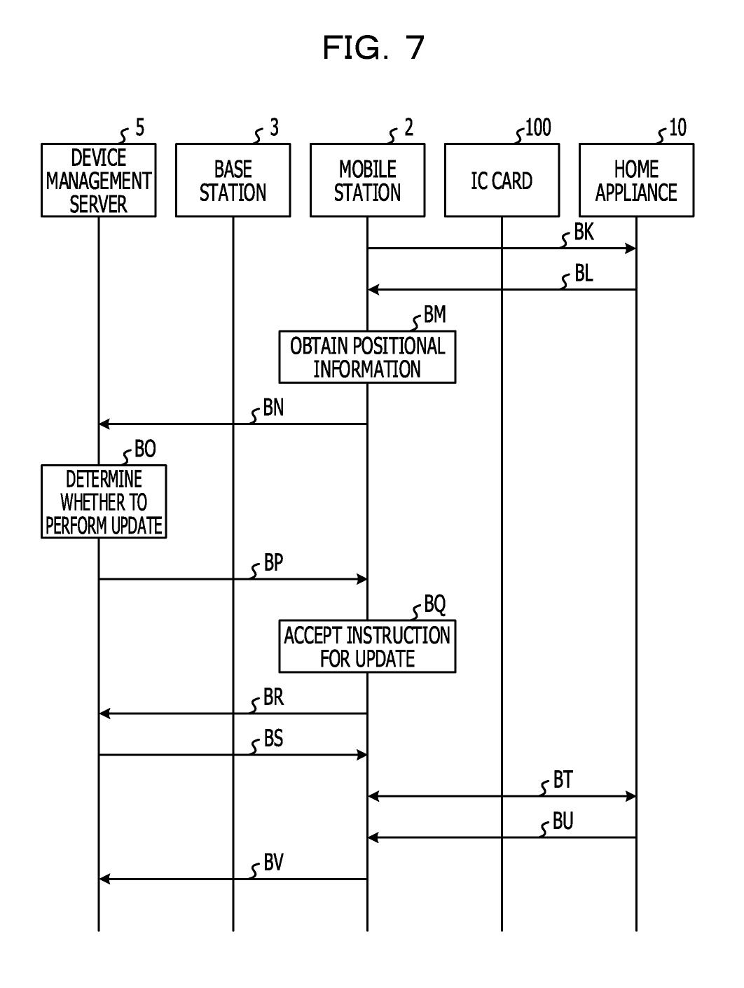

FIGS. 6 and 7 each illustrate an operation sequence of update data confirmation processing. In the update data confirmation processing, the mobile station 2 checks whether the device management server 5 includes update data for the home appliance 10. If update data is included, the mobile station 2 performs processing to update the control program or add-on function of the home appliance 10.

In BA, attachment processing is performed, in which the mobile station 2 is registered on a network intended for mobile communication services. In the attachment processing, mutual authentication is performed between the mobile station 2 and the network intended for mobile communication services. Mutual authentication, which uses the infrastructure of the mobile communication services, reduces impropriety in a segment in which mobile communication services is used on a communication path between the device management server 5 and the mobile station 2.

In BB, the mobile station 2 performs processing to authenticate the user who will activate the management application program. BB is similar to AA in FIG. 5. In BC, when the management application program is activated, the mobile station 2 accepts, on the GUI according to the management application program, an operation for requesting the update data confirmation processing for the home appliance 10. BC is performed by the update confirmation unit 107.

In BD, the mobile station 2 reads out an IMSI from the IC card 100. In BE, the mobile station 2 requests the home appliance 10 to transmit the device identifier of the home appliance 10. BD and BE are performed by the authentication unit 104.

In BF, the home appliance 10 transmits the device identifier of the home appliance 10 in response to the request for transmitting the device identifier from the mobile station 2. BF is performed by the response unit 205.

In BG, the mobile station 2 authenticates the home appliance 10. Specifically, if the registered product information 121 associates the device identifier received from the home appliance 10 with the IMSI, the mobile station 2 authenticates the home appliance 10. BG is performed by the authentication unit 104.

In BH, the mobile station 2 and device management server 5 perform processing to establish prescribed encrypted communication. BH is performed by the second communication unit 102 and communication unit 300. In BI, the mobile station 2 transmits the user identifier and password to the device management server 5. BI is performed by the authentication unit 104.

In BJ, the device management server 5 performs processing to authenticate the user who will undergo the after-sales care processing. Specifically, if the received user identifier and password match the user identifier and password stored in the storage unit 307 as the user information 310, the device management server 5 authenticates the user. BJ is performed by the authentication unit 301. BD through BJ may be referred to as usage authentication processing.

In BK, the mobile station 2 requests the home appliance 10 to transmit device information. BK is performed by the device information obtaining unit 105. In BL, the home appliance 10 transmits the product information 210 to the mobile station 2 as device information. BL is performed by the response unit 205.

In BM, the mobile station 2 obtains positional information about the mobile station 2. BM is performed by the positioning unit 106. In BN, the mobile station 2 transmits the received product information, the positional information about mobile station 2, and the user information 120 to the device management server 5. BN is performed by the update confirmation unit 107 and user information registration unit 108.

In BO, the device management server 5 determines whether there is update data for the home appliance 10. BO is performed by the update unit 302. At that time, the user information registration unit 303 updates the user information 310 stored in the storage unit 307 with the user information received from the mobile station 2.

In BP, when there is update data, the device management server 5 transmits update information, which indicates that there is update data, to the mobile station 2. BP is performed by the update unit 302.

In BQ, the mobile station 2 displays, on the GUI according to the management application program, information indicating that there is update data. The mobile station 2 accepts, from the user, an operation for requesting update of the control program or add-on function of the home appliance 10. In BR, the mobile station 2 requests the device management server 5 to transmit the update data. BQ and BR are performed by the update unit 109. In BS, the device management server 5 transmits the update data to the mobile station 2. BS is performed by the update unit 302.

In BT, the mobile station 2 and home appliance 10 perform processing to update the control program or add-on function of the home appliance 10 with the update data. BT is performed by the update unit 109 and update unit 206.

The update unit 109 transmits the update data to the home appliance 10 through, for example, a wired or wireless interface used for communication with the mobile station 2. The update unit 206 receives the update data from the mobile station 2 and updates the control program or add-on function with the received update data.

The update unit 109 may write the update data to a recording medium. The update unit 206 may read out the update data written to the recording medium and may update the control program or add-on function of the home appliance 10 with the read-out update data.

In BU, the home appliance 10 notifies the mobile station 2 that the control program or add-on function has been updated. BU is performed by the update unit 206. In BV, the mobile station 2 notifies the device management server 5 that the control program or add-on function of the home appliance 10 has been updated. BV is performed by the update unit 109. This completes the update data confirmation processing.

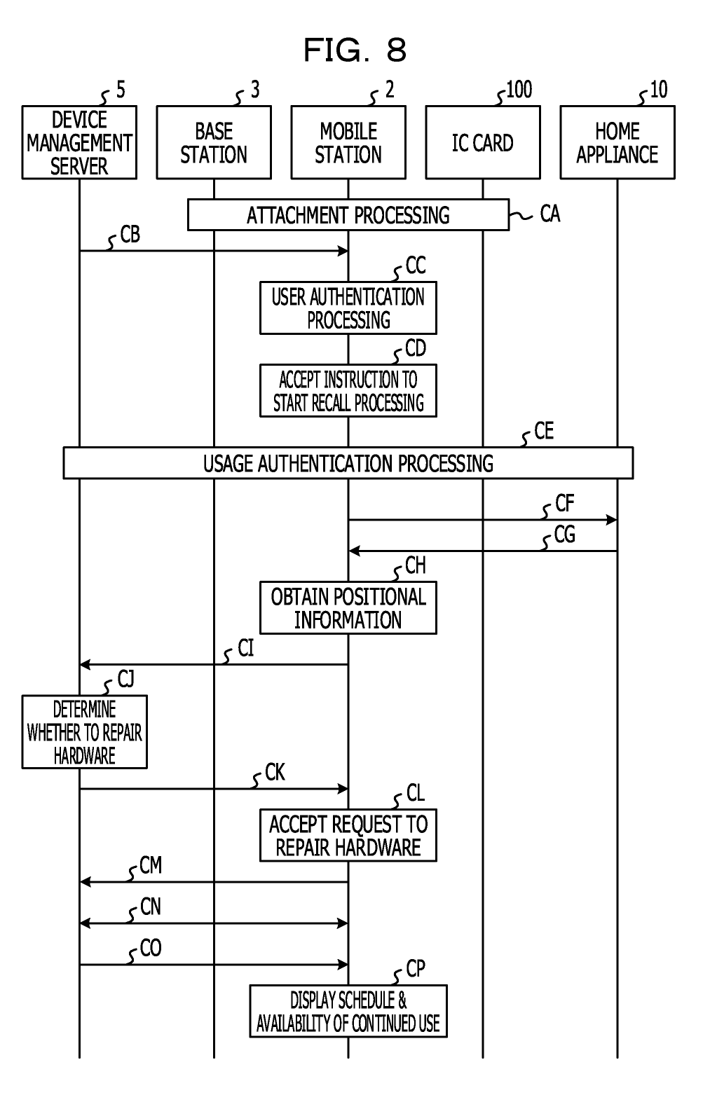

FIG. 8 illustrates an operation sequence of a processing performed at occurrence of a recall. CA is similar to BA in FIG. 6. In CB, if a recall occurs, the device management server 5 identifies a home appliance 10 eligible for being recalled and notifies the mobile station 2 corresponding to the user of the home appliance 10 that a recall has occurred. CB is performed by the maintenance unit 304.

In CC, the mobile station 2 performs processing to authenticate a user who will activate the management application program. CC is similar to AA in FIG. 5. In CD, when the management application program is activated, the mobile station 2 accepts, on the GUI according to the management application program, an operation for requesting the recall processing for the home appliance 10. CD is performed by the maintenance unit 110. Upon receipt of a notification of the recall, the maintenance unit 110 may automatically perform the recall processing. In CE, usage authentication processing similar to the usage authentication processing performed in BD through BJ in FIG. 6 is performed.

In CF, the mobile station 2 requests the home appliance 10 to transmit device information. CF is performed by the device information obtaining unit 105. In CG, the home appliance 10 transmits the product information 210, status information 211, and error information 212 to the mobile station 2 as device information. CG is performed by the response unit 205.

In CH, the mobile station 2 obtains the positional information about the mobile station 2. CH is performed by the positioning unit 106. In CI, the mobile station 2 transmits the received product information, the received status information, the received error information, the obtained positional information, and the user information 120 to the device management server 5. CI is performed by the update confirmation unit 107 and user information registration unit 108.

In CJ, the device management server 5 determines, based on the recall information 314, whether the home appliance 10 is eligible for being recalled. If the home appliance 10 is eligible for being recalled, the device management server 5 determines the product status of the home appliance 10 based on the status information and error information about the home appliance 10 and determines whether it is desirable to repair the hardware of the home appliance 10. CJ is performed by the maintenance unit 304.

At that time, the user information registration unit 303 updates the user information 310 stored in the storage unit 307 with the user information received from the mobile station 2.

In CK, if it is desirable to repair the hardware of the home appliance 10, the device management server 5 transmits, to the mobile station 2, repair guidance information that prompts the user to issue a repair request. CK is performed by the maintenance unit 304.

In CL, the mobile station 2 displays repair guidance information on the GUI according to the management application program. The mobile station 2 accepts, on the GUI, an operation to request to repair the home appliance 10. In CM, the mobile station 2 notifies the device management server 5 of the request to repair the home appliance 10. CL and CM are performed by the maintenance unit 110.

In CN, repair requirements are adjusted between a maintenance person and the user. The maintenance person and user may perform CN by telephone, mail, or another method. In another embodiment, CN may be performed by the device management server 5 executing an automatic response program through a dialogue with the user who operates the mobile station 2 to make input operations. In this case, CN is performed by the maintenance unit 110 and maintenance unit 304.

In CO, the device management server 5 notifies the mobile station 2 that the repair request has been accepted. CO is performed by the maintenance unit 304. In CP, the mobile station 2 displays the repair schedule and availability of continued use of the home appliance 10 for the user. CP is performed by the maintenance unit 110. This completes the processing performed at the occurrence of a recall.

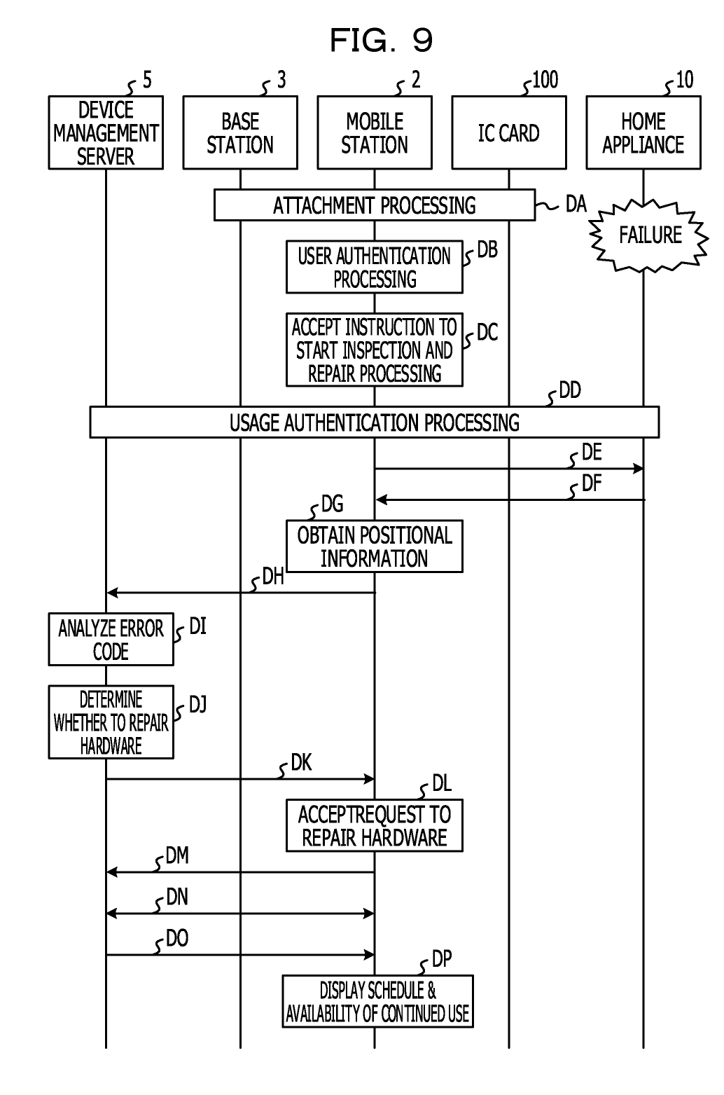

FIG. 9 illustrates an operation sequence of a processing performed at occurrence of a failure. DA is similar to BA in FIG. 6. In DB, the mobile station 2 performs processing to authenticate a user who will activate the management application program. DB is similar to AA in FIG. 5.

In DC, when the management application program is activated, the mobile station 2 accepts an operation, on the GUI according to the management application program, for requesting the inspection and repair processing for the home appliance 10. DC is performed by the maintenance unit 110. In DD, usage authentication processing similar to the usage authentication processing BD through BJ in FIG. 6 is performed.

DE through DH are similar to CF through CI in FIG. 8. In DI, the device management server 5 determines a type of failure of the home appliance 10 based on an error code included in the error information. DI is performed by the maintenance unit 304. DJ through DP are similar to CJ through CP in FIG. 8. This completes processing performed at the occurrence of a failure.

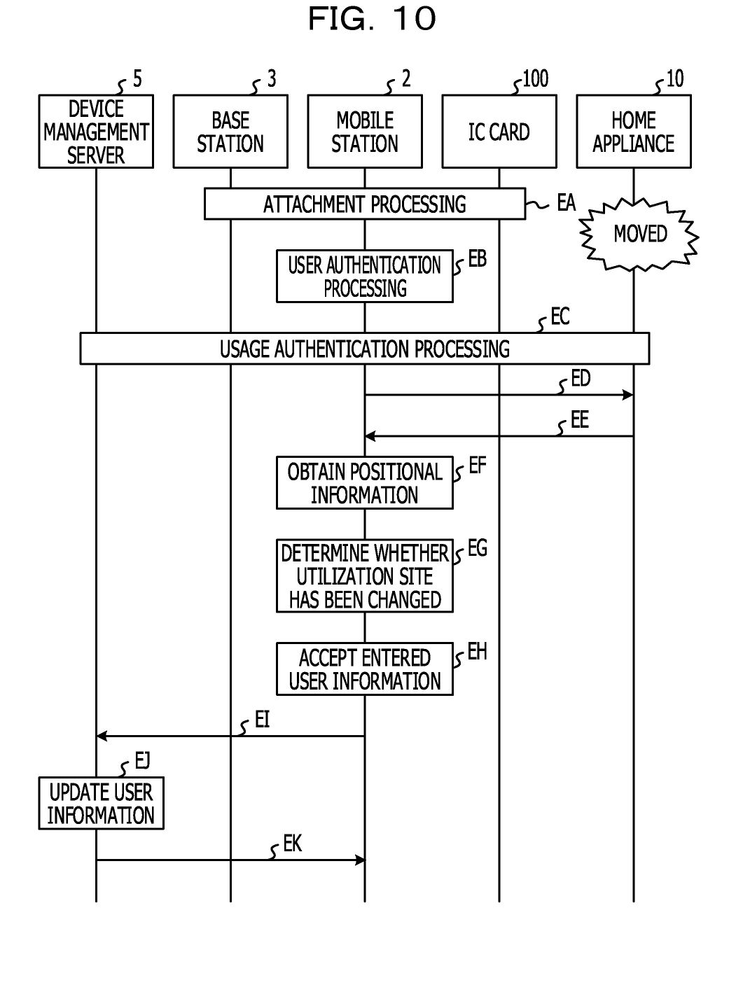

FIG. 10 illustrates an operation sequence of a processing performed when a utilization site of the home appliance 10 is changed. EA is similar to BA in FIG. 6. EB is similar to AA in FIG. 5.

After the management application program has been activated, the mobile station 2 accepts, from the user, any operation to receive the after-sales care processing on the GUI according to the management application program. This operation may be to request the update data confirmation processing described above (as in BC), to request the recall processing described above (as in CD), or to request other processing. In EC, usage authentication processing similar to the usage authentication processing BD through BJ in FIG. 6 is performed.

ED through EF are similar to CF through CH in FIG. 8. In EG, the mobile station 2 determines, based on a previous history of the positional information 123 about the mobile station 2 that has been obtained by the positioning unit 106, whether the user of the mobile station 2 has moved to another place, that is, the utilization site of the home appliance 10 has been changed.

In EH, when it is determined that the user has moved, the mobile station 2 makes an inquiry to the user about whether to update the address information about the user in the user information 120 stored in the storage unit 113 and accepts an input of user information for updating, on the GUI according to the management application program. The mobile station 2 updates the user information 120 stored in the storage unit 113 with the accepted user information. EG and EH are performed by the user information registration unit 108.

In EI, the mobile station 2 transmits the device information obtained in EE and the user information 120 to the device management server 5. The transmission of user information 120 in EI is performed by the user information registration unit 108.

In EJ, the device management server 5 updates the user information 310 stored in the storage unit 307 with the received user information. In EK, the device management server 5 notifies the mobile station 2 that the user information 310 has been updated. EJ and EK are performed by the user information registration unit 303. This completes processing performed when the utilization site of the home appliance 10 is changed.

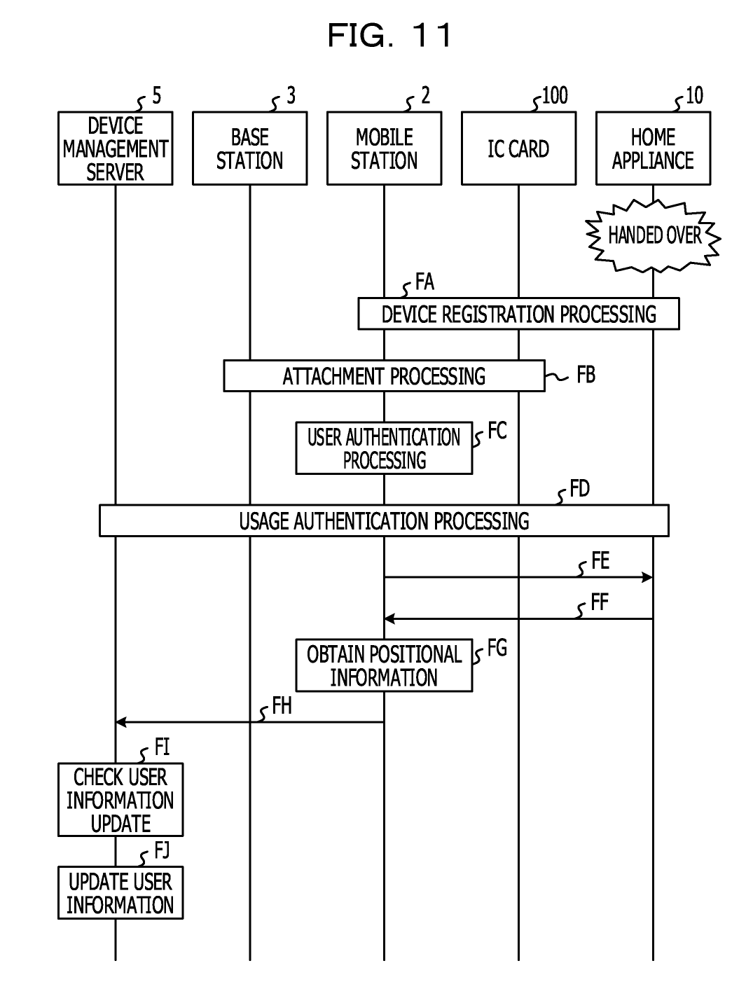

FIG. 11 illustrates an operation sequence of a processing performed when the home appliance 10 is handed over. In FA, the device registration processing is performed for a handed-over home appliance 10. The device registration processing in FA is similar to AA through AF in FIG. 5. FB through FH are similar to EA through EF and EI in FIG. 10.

In FI, the device management server 5 determines, based on the product information 311 about the home appliance 10 and the device identifier stored in the user information 310, whether the home appliance 10 is a home appliance owned by the user of the mobile station 2. In FJ, if the home appliance 10 is not a home appliance owned by the user of the mobile station 2, the device management server 5 registers the device identifier of the home appliance 10 in the user information 310 as the device identifier of a home appliance owned by the user.

In FI, the device management server 5 also determines whether the device identifier in the product information 311 about the home appliance 10 has been registered in user information about another user as the device identifier of a home appliance owned by the other user. In FJ, if the device identifier of the home appliance 10 has been registered in the user information about the other user, the device management server 5 also removes the registration. FI and FJ are performed by the user information registration unit 303. This completes processing performed when the home appliance 10 is handed over.

When the mobile station 2 used by the user of the home appliance 10 is changed, the user's account registered in the device management server 5 is changed. In this case as well, processing similar to FA through FJ in FIG. 11 are performed.

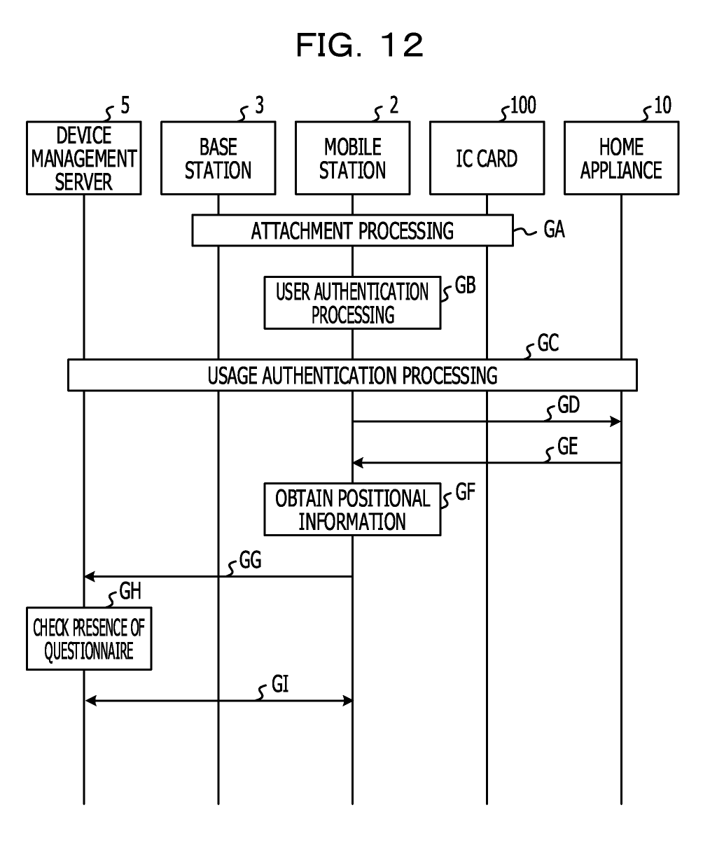

FIG. 12 illustrates an operation sequence of a processing performed when a response to a questionnaire is collected. GA through GG are similar to EA through EF and EI in FIG. 10.

In GH, the device management server 5 determines, based on the product information 311 about the home appliance 10, whether there is a questionnaire available for the home appliance 10. GH is performed by the information providing unit 305. The information providing unit 305 may determine, based on the positional information about the mobile station 2 or address information about the user, whether there is an available questionnaire.

In GI, when there is an available questionnaire, the device management server 5 and mobile station 2 notify of a questionnaire to the user of the home appliance 10 and collects a response of the user to the questionnaire. GI is performed by the information providing unit 111, information collection unit 112, information providing unit 305, and information collection unit 306. This completes processing performed when a response to a questionnaire is collected.

In GH, the device management server 5 may determine whether there is other information that may be provided, instead of notifying the user of a questionnaire. Examples of the other information to be provided may include guidance of events and new products related to the home appliances 10, information about operation procedures, and a notification of a recruitment of monitors. In GI, the device management server 5 transmits, to the mobile station 2, information that may be provided.

Alternatively, the mobile station 2 may download a product manual for the home appliance 10 from the device management server 5, instead of performing GH and GI. This download processing is performed by the information providing unit 111 and information providing unit 305.

According to this embodiment, it is possible to perform the after-sales care processing intended for the home appliance 10, which lacks a communication interface directly connectable to the communication network 4 or to a wireless access network intended for mobile communication service, in online processing through the mobile station 2. Thus, manual processing performed by the user in the after-sales care processing may be reduced. It is also possible to perform shipped product management and customer management involved in this home appliance 10 in online processing through the mobile station 2.

In the after-sales care processing, communication between the device management server 5 and the mobile station 2 is authenticated and a home appliance 10 eligible for undergoing the after-sales care processing is authenticated by using a combination of the device identifier of the home appliance 10 and an identifier available to identify the mobile station 2 or its user. This keeps a third party (i.e., a person other than the user of the home appliance 10) from illegally undergoing the after-sales care processing. For example, it is suppressed that a third party updates the control program or add-on function of the home appliance 10 in an unauthorized manner.

According to this embodiment, the device management server 5 may determine whether to perform the after-sales care processing for the home appliance 10, determine whether to repair the home appliance 10, and determine a person or an organization responsible for performing repair work for the home appliance 10, according to the positional information about the mobile station 2, which has been obtained through the mobile station 2. Therefore, detailed after-sales care processing may be provided for the home appliance 10.

According to this embodiment, the mobile station 2 prompts the user to update the information about the utilization site of the home appliance 10, which has been stored as the user information 120, according to the positional information 123 about the mobile station 2. The device management server 5 may determine whether to perform the after-sales care processing for the home appliance 10, determine whether to repair the home appliance 10, and determine an organization or a person responsible for performing repair work for the home appliance 10, according to the utilization site of the home appliance 10, which has been obtained through the mobile station 2. Therefore, detailed after-sales care processing may be provided for the home appliance 10.

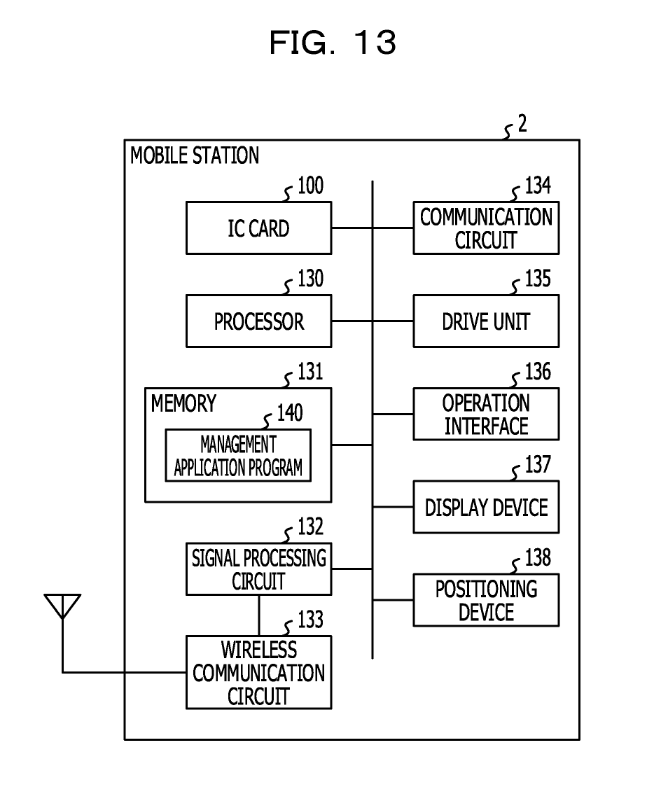

FIG. 13 is a block diagram illustrating an exemplary hardware configuration of the mobile station 2. In addition to the IC card 100, the mobile station 2 includes a processor 130, a memory 131, a signal processing circuit 132, a wireless communication circuit 133, a communication circuit 134, a drive unit 135, an operation interface 136, a display device 137, and a positioning device 138. A management application program 140 is stored in the memory 131.

The management application program 140 causes the processor 130 to perform the above-described processing of the first communication unit 101 in cooperation with the communication circuit 134. The management application program 140 also causes the processor 130 to perform the above-described processing of the second communication unit 102 in cooperation with the signal processing circuit 132 and wireless communication circuit 133.

The management application program 140 also causes the processor 130 to perform the above-described processing of the registration unit 103, authentication unit 104, device information obtaining unit 105, and update confirmation unit 107. The management application program 140 also causes the processor 130 to perform the above-described processing of the user information registration unit 108, update unit 109, maintenance unit 110, information providing unit 111, and information collection unit 112.

The drive unit 135 is used when the update unit 109 writes update data to a recording medium. The operation interface 136 is used to accept the user's operation on the mobile station 2. The display device 137 is used to display the GUI according to the management application program 140. The positioning device 138 performs the above-described processing of the positioning unit 106. A storage area of the storage unit 113 is provided in the memory 131.

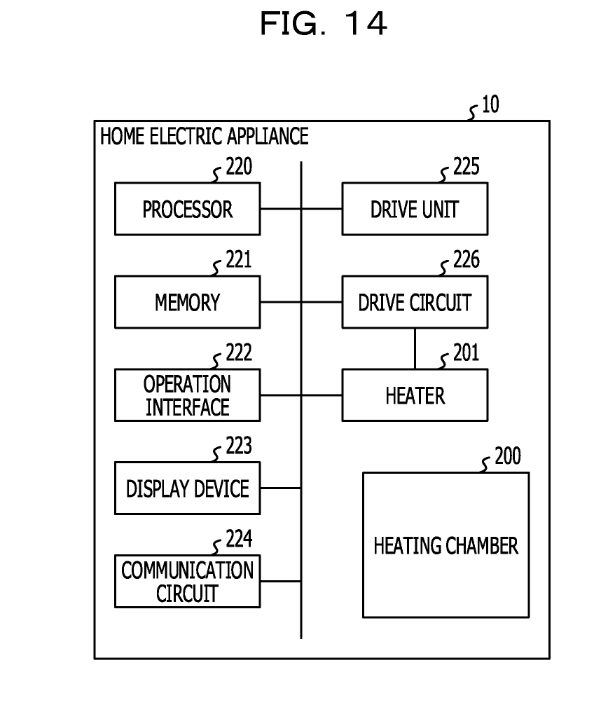

FIG. 14 is a block diagram illustrating an exemplary hardware configuration of the home appliance 10. In addition to the heating chamber 200 and heater 201, the home appliance 10 includes a processor 220, a memory 221, an operation interface 222, a display device 223, a communication circuit 224, a drive unit 225, and a drive circuit 226. The processor 220 performs the above-described processing of the communication unit 202 in cooperation with the communication circuit 224. The processor 220 also performs the above-described processing of the registration unit 203, status diagnosis unit 204, response unit 205, and update unit 206.

The drive unit 225 is used when the update unit 206 reads out update data from a recording medium. A storage area of the storage unit 207 is provided in the memory 221.

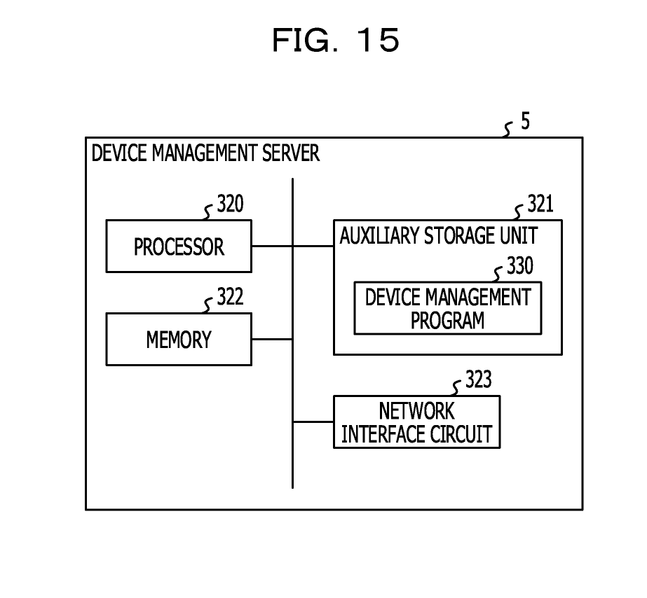

FIG. 15 is a block diagram illustrating an exemplary hardware configuration of the device management server 5. The device management server 5 includes a processor 320, an auxiliary storage unit 321, a memory 322, and a network interface circuit 323. A device management program 330 is stored in the auxiliary storage unit 321.

The device management program 330 causes the processor 320 to perform the above-described processing of the communication unit 300 in cooperation with the network interface circuit 323. The device management program 330 also causes the processor 320 to perform the above-described processing of the authentication unit 301, update unit 302, user information registration unit 303, maintenance unit 304, and information providing unit 305, and information collection unit 306. A storage area of the storage unit 307 is provided in the auxiliary storage unit 321.

The hardware configurations illustrated in FIGS. 13 to 15 have been taken only as examples to describe an embodiment. The mobile station, home appliances, and device management server described in this description may use any other hardware configuration as long as they perform the operations described above.

Block diagrams in FIGS. 2 to 4 mainly illustrate configurations related to the functions described in this description. The mobile station, home appliances, and device management server may include any other constituent elements. Series of operations described with reference to FIGS. 5 to 12 may be each construed as being a method including a plurality of operations.

All examples and conditional language recited herein are intended for pedagogical purposes to aid the reader in understanding the various embodiments described herein and the concepts contributed by the inventor to furthering the art, and are to be construed as being without limitation to such specifically recited examples and conditions, nor does the organization of such examples in the specification relate to a showing of the superiority and inferiority of the various embodiments described herein. Although the embodiments of the present invention have been described in detail, it should be understood that the various changes, substitutions, and alterations could be made hereto without departing from the spirit and scope of the invention.

What is claimed is:

1. A mobile station apparatus comprising:
a memory; and
a processor configured to
receive a first identifier used to identify an electronic device other than the mobile station apparatus,
authenticate the electronic device by using a combination of the first identifier and a second identifier, the second identifier being available to identify the mobile station apparatus or a user of the mobile station apparatus, and
obtain first data about the authenticated electronic device from a server apparatus through authenticated communication between the mobile station apparatus and the server apparatus.

2. The mobile station apparatus according to claim 1, wherein
the processor is further configured to
identify a location of the mobile station apparatus,
transmit second data about the identified location to the server apparatus, and
obtain, as the first data, data selected by the server apparatus according to the location.

3. The mobile station apparatus according to claim 1, wherein
the processor is further configured to
identify a location of the mobile station apparatus,
detect a change in a utilization site of the authenticated electronic device based on the identified location,
accept, upon detecting the change in the utilization site, user information entered by the user to update second data about the utilization site,
transmit the accepted user information to the server apparatus, and
obtain, as the first data, data selected by the server apparatus according to the user information.

4. The mobile station apparatus according to claim 1, wherein
the processor is further configured to
obtain device information that includes data indicating one of a device status of the authenticated electronic device and an error history of the authenticated electronic device,
transmit the obtained device information to the server apparatus, and
obtain, as the first data, data selected by the server apparatus according to the device information.

5. The mobile station apparatus according to claim 1, wherein
the first data is update data for updating one of a control program of the authenticated electronic device and an add-on function of the authenticated electronic device, and
the processor is further configured to
update the control program or the add-on function upon obtaining the update data.

6. The mobile station apparatus according to claim 1, wherein
the first data is a notification that prompts the user to issue a repair request for repairing the authenticated electronic device, and
the processor is further configured to
accept the repair request entered by the user, and
transmit the repair request to the server apparatus.

7. The mobile station apparatus according to claim 1, wherein
the first data is a questionnaire about the authenticated electronic device, and
the processor is further configured to
accept a response result entered by the user in response to the questionnaire, and
transmit the response result to the server apparatus.

8. A communication method comprising:
receiving, by a mobile station apparatus, a first identifier used to identify an electronic device other than the mobile station apparatus;
authenticating the electronic device by using a combination of the first identifier and a second identifier, the second identifier being available to identify the mobile station apparatus or a user of the mobile station apparatus; and
obtaining data about the authenticated electronic device from a server apparatus through authenticated communication between the mobile station apparatus and the server apparatus.

9. A computer-readable recording medium having stored therein a program for causing a computer to execute a process, the process comprising:
receiving a first identifier used to identify an electronic device other than the computer;
authenticating the electronic device by using a combination of the first identifier and a second identifier, the second identifier being available to identify the computer or a user of the computer; and
obtaining data about the authenticated electronic device from a server apparatus through authenticated communication between the computer and the server apparatus.
